(19) United States
(12) Patent Application Publication
(10) Pub. No.: US 2014/0181455 A1
(43) Pub. Date: Jun. 26, 2014

(54) CATEGORY BASED SPACE ALLOCATION FOR MULTIPLE STORAGE DEVICES

(71) Applicant: APPLE INC., Cupertino, CA (US)

(72) Inventors: Wenguang WANG, Santa Clara, CA (US); David A. MAJNEMER, San Francisco, CA (US); John GARVEY, Victoria (CA)

(73) Assignee: APPLE INC., Cupertino, CA (US)

(21) Appl. No.: 13/830,685

(22) Filed: Mar. 14, 2013

Related U.S. Application Data
(60) Provisional application No. 61/740,361, filed on Dec. 20, 2012.

(51) Int. Cl. G06F 3/06

(52) U.S. Cl. CPC G06F 3/0608
USPC 711/171

(57) ABSTRACT

The invention provides a technique for carrying out a request to store data. The technique includes the steps of receiving, from an application, the request to store data, and determining a storage functionality associated with the request. The storage functionality represents a particular storage function (e.g., RAID-5) that can be implemented using space available in one or more storage devices that are associated with the storage functionality. Identifications of the one or more storage devices, as well as a size of the data, are transmitted to a space allocator. In turn, the space allocator analyzes various aspects of the one or more storage devices (e.g., amount of free space therein) and allocates space within at least one of the one more storage devices according to the analysis. Information about the space allocations is then used to issue In/Out (I/O) commands that cause the storage functionality to be implemented.

### CROSS REFERENCE TO RELATED APPLICATIONS

This application is related to, and claims the benefits of, U.S. Provisional Patent Application No. 61/740,361, filed on Dec. 20, 2012 entitled: CATEGORY BASED SPACE ALLOCATION FOR MULTIPLE STORAGE DEVICES, which is hereby incorporated by reference herein in its entirety.

### TECHNICAL FIELD

The invention relates generally to management of data storage devices. More particularly, the invention relates to a category-based technique for managing space allocations within multiple storage devices.

### BACKGROUND

Space allocation policy techniques are an important aspect of any computer system that supports multiple storage devices, such as an array of hard disk drives and/or solid state drives. One well-known technology for managing multiple storage devices is RAID (redundant array of inexpensive disk) technology, which provides a variety of approaches for how data is stored within the multiple storage devices. Some RAID approaches are directed to providing data redundancy (e.g., mirroring data across storage devices with RAID-1), while other RAID approaches are directed to providing increased speed (e.g., striping data across storage devices with RAID-5). These RAID approaches can therefore enable users to tailor their storage devices to function in a manner that best-meets software application demands, such as fast database performance and high-availability.

Notably, conventional RAID approaches require that each storage device that provides storage support to a particular RAID configuration (e.g., RAID-1) cannot also provide storage support to a different type of RAID configuration (e.g., RAID-5). Consider, for example, a storage system that includes a first storage device that supports a RAID-1 configuration and possesses 75% free storage space. Consider further that the storage system includes a second storage device that supports a RAID-5 configuration but does not possess any free storage space. In this scenario, when a write request is directed to the second (RAID-5) storage device—which has no free space—the write request cannot instead be redirected to the free storage space available within the first (RAID-1) storage device. As a result, at least one new storage device must be added to the RAID-5 configuration despite the availability of free storage space within the neighboring RAID-1 configuration, which constitutes wasteful and inefficient over-provisioning.

Accordingly, what is needed in the art is a technique that enables flexible storage across multiple devices without sacrificing overall robustness.

### SUMMARY

This paper describes various embodiments that relate to a category-based space allocation technique that mitigates several of the problems associated with conventional storage techniques (e.g., conventional RAID technologies). In particular, the category-based space allocation technique described herein enables space sharing among arbitrary types of disk arrays while achieving the same degree of robustness as traditional disk arrays.

One embodiment of the invention sets forth a method for carrying out a request to store data generated by an application. The method includes the steps of receiving, from the application, the request to store data, and determining a storage functionality associated with the request, wherein the storage functionality is implementable using one or more storage devices. The method further includes the steps of transmitting, to a space allocator: identifications of the one or more storage devices, and a size of the data. In turn, the method further includes the steps of receiving, from the space allocator, information about space allocated within at least one of the one or more storage devices, and issuing, based on the information, one or more In/Out (I/O) commands to store the data in a manner that implements the storage functionality.

Another embodiment of the invention sets forth a method for carrying out a request to allocate space within one or more storage devices. The method includes the steps of receiving, from a storage manager, a request that includes: identifications of the one or more storage devices, and a size of data to be stored. The method further includes the steps of selecting, from the one or more storage devices, at least one storage device in which an amount of space equal to the size of data can be allocated, allocating, within each of the selected storage devices, an amount of space equal to the size of data. The method includes a final step of transmitting, to the storage manager, information about the space allocations, whereupon the storage manager generates I/O commands based on the information to store the data in a manner that implements the storage functionality.

Yet another embodiment of the invention sets forth a method for adding a storage device to a collection of storage devices. The method includes the steps of detecting the addition of the storage device, and executing one or more benchmark tests against the storage device to establish characteristics of the storage device. The method further includes the steps of identifying, based on the established characteristics of the storage device, at least one storage functionality that the storage device is capable of supporting, and updating a data structure to include at least one reference to the storage device.

Other embodiments include a non-transitory computer readable medium storing instructions that, when executed by a processor, cause the processor to carry out any of the method steps described above. Further embodiments include a system that includes at least a processor and a memory storing instructions that, when executed by the processor, cause the processor to carry out any of the method steps described above.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The included drawings are for illustrative purposes and serve only to provide examples of possible structures and arrangements for the disclosed inventive apparatuses and methods for providing portable computing devices. These drawings in no way limit any changes in form and detail that may be made to the invention by one skilled in the art without departing from the spirit and scope of the invention. The embodiments will be readily understood by the following detailed description in conjunction with the accompanying drawings, wherein like reference numerals designate like structural elements.

FIG. 1 illustrates a block diagram of a computing device configured to implement embodiments of the invention.

FIG. 2 illustrates a conceptual diagram of a hierarchical breakdown of components included in the computing device of FIG. 1 that are configured to carry out the techniques described herein, according to one embodiment of the invention.

FIGS. 3A-3C illustrate conceptual diagrams of example assignments of storage devices to categories and subcategories, according to one embodiment of the invention.

FIG. 4 illustrates a method for receiving and handling a write request generated by a user application, according to one embodiment of the invention.

FIG. 5 illustrates a method for managing requests to allocate space within one or more storage devices, according to one embodiment of the invention.

FIG. 6A illustrates a method for adding a new storage device to a collection of storage devices, according to one embodiment of the invention.

FIG. 6B illustrates a method for removing a storage device from a collection of storage devices, according to one embodiment of the invention.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

As described in greater detail below, embodiments of the invention provide a technique for enabling a storage manager and a space allocator to flexibly manage available space within a plurality of storage devices. In particular, the storage manager maintains a physical volume (PV) group identification (ID) data structure that includes information about which storage devices can be used to provide particular storage functionalities, such as those directed to providing a particular quality of service (QoS) (e.g., through read/write speeds), high availability (e.g., through data redundancy), and the like. The storage manager is configured to receive and process write requests generated by software applications. In particular, when the storage manager receives a write request, the storage manager first analyzes various aspects associated at least with the application and the write request to determine a storage functionality that is most-suitable to support the write request. For example, the storage manager can determine that a write request received from an application that is frequently accessed by a user should be directed to a fastest-available storage device. The storage manager then identifies, using the PV group ID data structure, one or more storage devices that are capable of supporting the determined storage functionality, and forwards information to a space allocator to allocate space that can be used to satisfy the write request.

In turn, the space allocator analyzes the information provided by the storage manager to determine the storage devices that are most-suitable from which to allocate space to satisfy the write request. More specifically, when several storage devices are available to support a particular storage functionality—such as a storage functionality related to high-speed performance—the space allocator can analyze each of the several storage devices to identify at least one storage device that is most appropriate from which to allocate space. After the allocations are carried out, the space allocator forwards to the storage manager at least one tuple that includes a physical address pointer to memory address within one of the storage devices, and, further, a corresponding length of free blocks that follow the memory address. Using these tuples, the storage manager generates I/O operations such that the write request is collectively executed and the storage functionality is effectively provided.

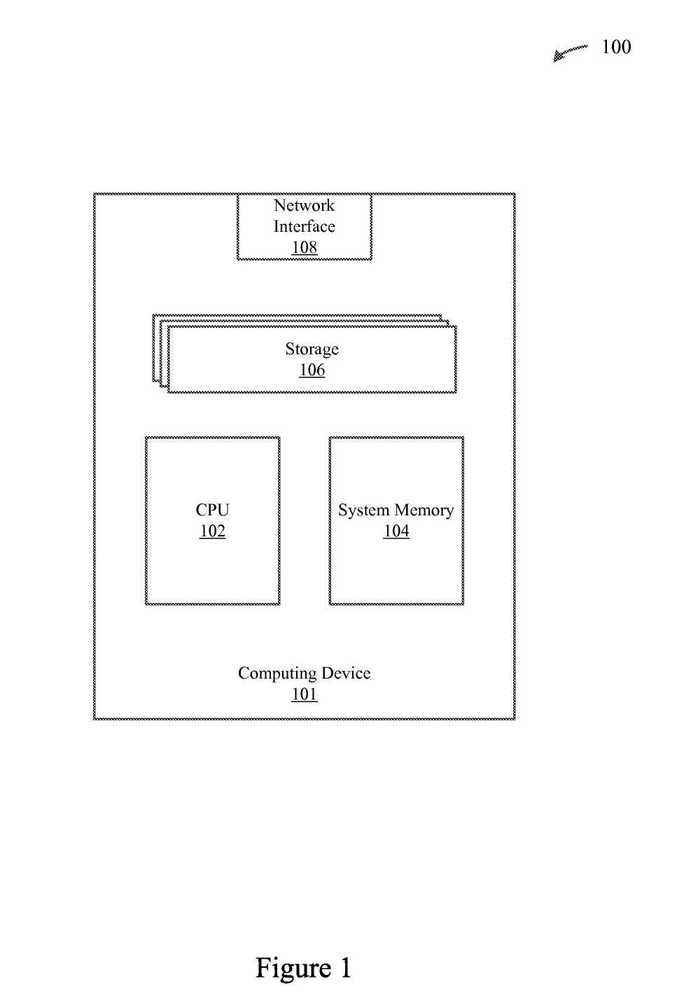

As set forth above, various embodiments of the invention are directed to a category-based space allocation technique that mitigates several of the problems associated with conventional storage. A detailed description of the embodiments is provided below in conjunction with FIGS. 1, 2, 3A-3C, 4, 5, and 6A-6B. In particular, FIG. 1 illustrates a block diagram of a computing device 101 configured to implement embodiments of the invention. As shown in FIG. 1, the computing device 101 includes subsystems such as a central processing unit (CPU) 102, a system memory 104, a plurality of storage devices 106 (e.g., hard drives, solid state drives, tape drives), and a network interface 108. The central processing unit 102, for example, can execute computer program code (e.g., an operating system) to implement the invention. An operating system is normally, but necessarily, resident in the system memory 104 when the operating system is executing. Other computing devices suitable for use with the invention may include additional or fewer subsystems. For example, another computing device could include more than one central processor 102 (i.e., a multi-processor system) or a cache memory.

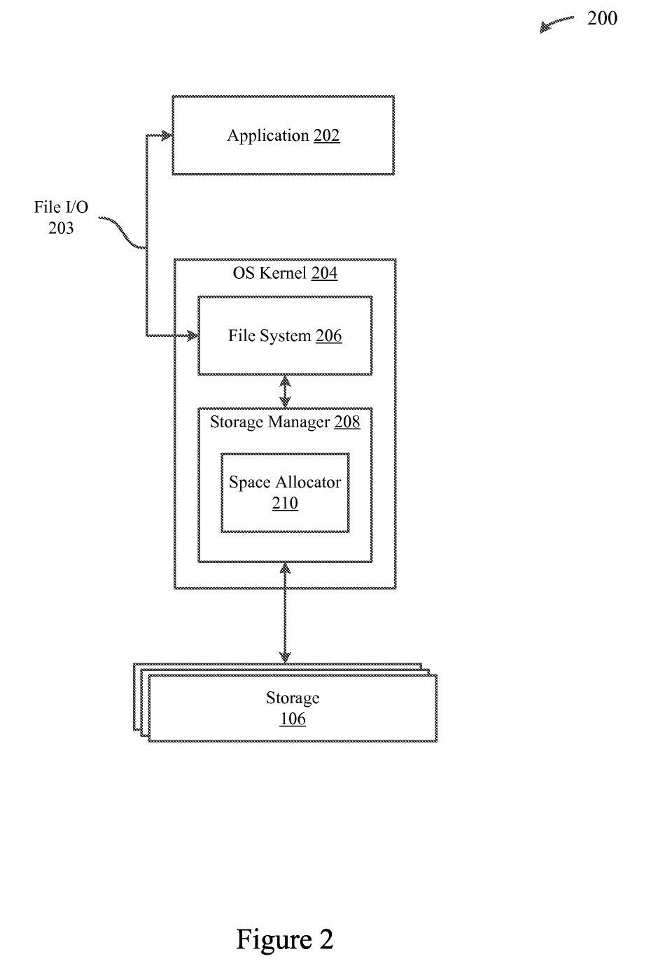

FIG. 2 illustrates a conceptual diagram of a hierarchical breakdown of components included in the computing device 101 that are configured to carry out the techniques described herein, according to one embodiment of the invention. As shown in FIG. 2, an application 202 (e.g., a user application) is configured to interface with an operating system (OS) kernel 204 and issue file I/O operation requests 203 to a file system 206 that is under control of the OS kernel 204. Also under the control of OS kernel 204 is a storage manager 208 that is configured to interface with the file system 206 and includes a space allocator 210, which is configured to manage storage space within the storage devices 106 according to the techniques set forth herein.

As described in greater detail herein, the storage manager 208 is configured to manage one or more physical volume (PV) group identifications (IDs). The PV group ID is a concatenation of two IDs: a category-ID and a subcategory-ID and can be represented by a tuple of the category-ID and the subcategory-ID (e.g., <category_ID, subcategory_ID>) and corresponds to a particular storage functionality (e.g., RAID-1). Each of the storage devices 106 is assigned to a single subcategory-ID for each category-ID that is managed by storage manager 208.

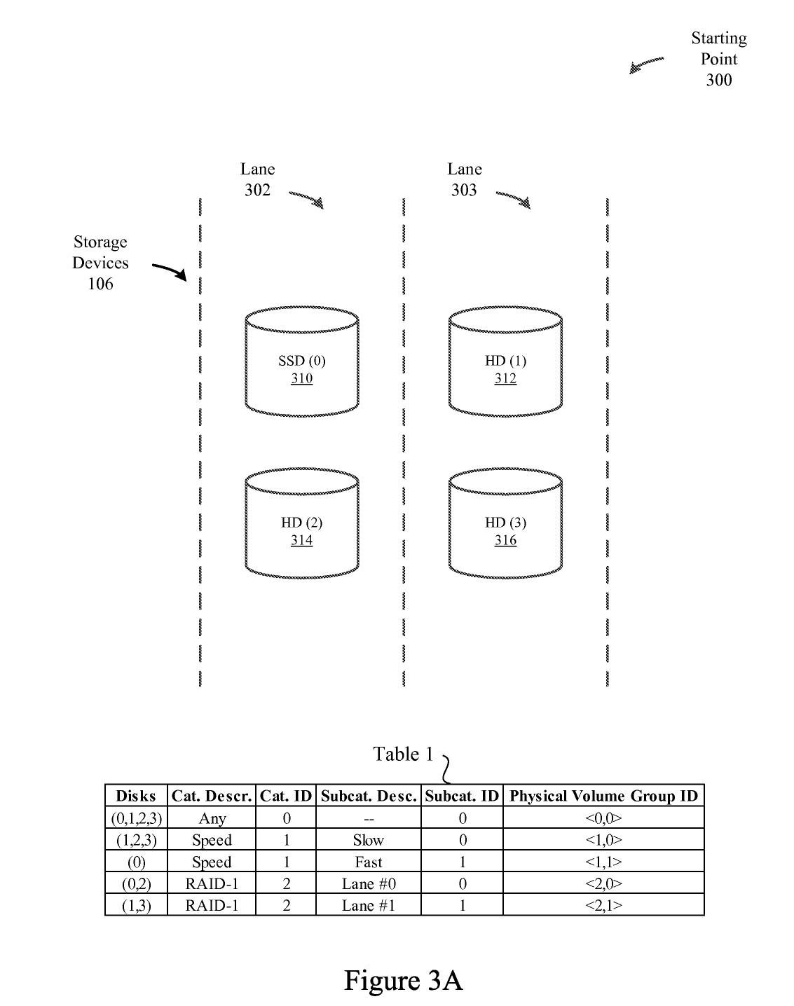

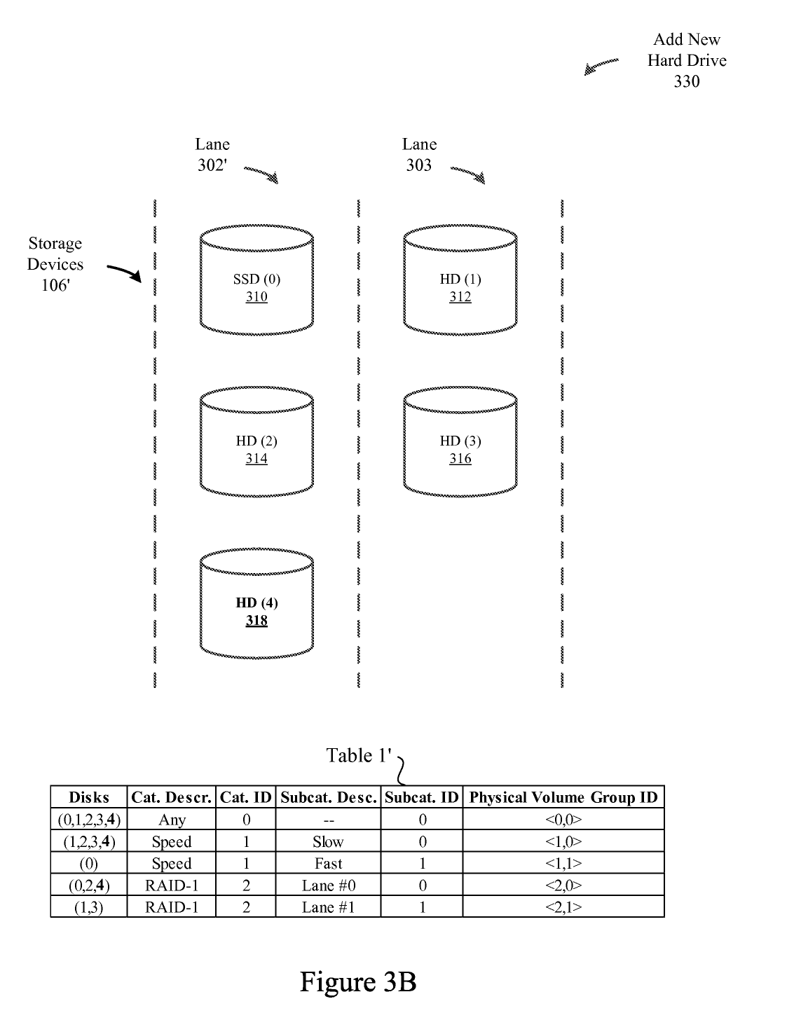

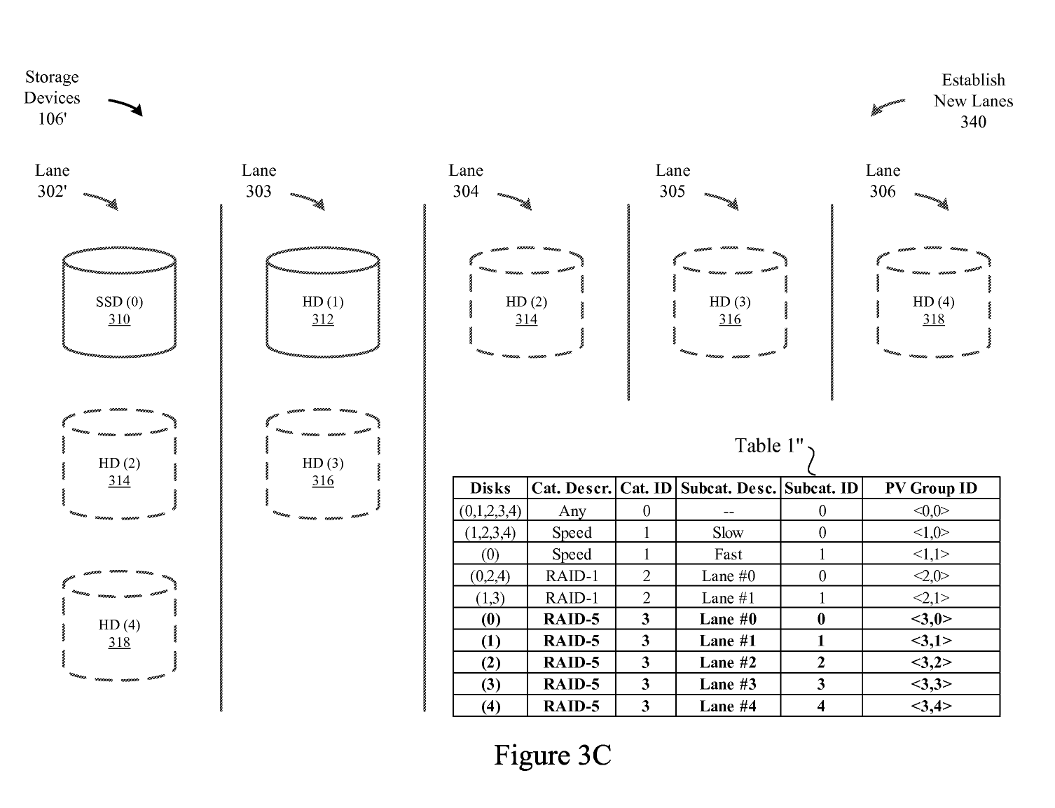

FIGS. 3A-3C illustrate conceptual diagrams of example assignments of storage devices to categories and subcategories, according to one embodiment of the invention. Specifically, FIG. 3A illustrates a starting point 300 of storage devices 106, which include a single solid state drive (SSD 310) and three hard disk drives (HD 312, HD 314 and HD 316). Table 1 specifies the manner in which the storage devices 106 are organized by the storage manager 208. Notably, the PV group ID <0,0> is reserved as a special PV group ID where the category-ID and subcategory-ID are each “0” and each of the storage devices 106 are assigned to the PV group ID <0,0>, which is reflected in the first row of Table 1. Such categorization enables the space allocator 210 to readily allocate free space in any of the storage devices 106 when, for example, a simple write request is received and advanced storage features (e.g., guaranteed redundancy or speed) are not associated with or required by the write request.

Also shown in Table 1 is a category-ID “1” that is related to a speed capability of the storage devices 106, which includes two subcategory-IDs: “0” for slow storage devices and “1” for fast storage devices. Accordingly, the slower storage devices HD 312, HD 314 and HD 316—which, again, are hard disk drives, and are slower than the SSD 310—are assigned to the subcategory-ID “0”, and the SSD 310 is assigned to the subcategory-ID “1”. Notably, any number of categories and corresponding subcategories can exist for speed-related functionality. For example, a subcategory can exist for different revolutions-per-minute (RPM) properties of the storage devices HD 312, HD 314 and HD 316. In this manner, subsequently-added storage devices can be “bucketed” into the proper subcategory related to the RPM parameters thereof Other examples of speed-related categories include those related to network-connected storage devices whose speeds are affected by the bandwidth of the network connection used to communicate with the storage devices.

Further shown in Table 1 is a category-ID “2” that is related to providing RAID-1 storage functionality using two or more of the storage devices 106. As shown in Table 1, the category-ID “2” includes two subcategory-IDs: “0” for a lane 302 and “1” for a lane 303, where lane 302 and lane 303 logically mimic the separation of storage devices when arranging storage devices to implement RAID-1 functionality. Notably, the RAID-1 storage functionality can be supported by storage space of storage devices 106 simultaneously and in conjunction with the other storage space supporting different storage functionalities. For example, the storage devices 106 can, in conjunction with providing RAID-1 functionality, be directed to providing the speed-based functionality related to the category-ID “1” described above, as well as more advanced storage functionality such as RAID-5 as described below in conjunction with FIG. 3C.

The techniques described herein enable storage devices to be added to the storage devices 106 and removed from the storage devices 106 to modify various aspects of the functionalities that are provided by the storage devices 106. For example, the addition of storage devices to the storage devices 106 may provide additional storage space. In some cases, the addition of storage devices to the storage devices 106 may also provide support for additional storage functionalities, e.g., establishing a third lane for storing parity bits to provide RAID-5 storage technology. For example, FIG. 3B highlights how the addition of a storage device can provide additional storage space within FIG. 3B. Moreover, FIG. 3C provides highlights how the added storage device of FIG. 3B can also be used to provide a new storage functionality.

FIG. 3B illustrates an event 330 that involves the addition of a new hard drive to the storage devices 106, which are represented as storage devices 106′ after an additional HD 318 is added to the storage devices 106. As shown in FIG. 3B, the Table 1 becomes Table 1′ and the contents thereof are updated to reflect the addition of the HD 318. In particular, the HD 318 is associated with the PV group ID <1,0> since the HD 318 is not a fast storage device, and, additionally, the HD 318 is associated with the PV group ID <2,0> such that the HD 318 is included in lane 302, which is represented in FIG. 3B as lane 302′ to account for the newly-added HD 318. Notably, the HD 318 could instead be associated with the PV group ID <2,1> such that the HD 318 is included in lane 303. In any case, the storage manager 208 can analyze each of the lanes to determine a most appropriate lane to which the HD 318 should be added, for example to keep balance across the lanes as storage devices are added to and removed from the storage devices 106.

FIG. 3C illustrates yet an additional example update 340 to Table 1′ (illustrated as Table 1″) that can occur after the addition of the HD 318 to the storage devices 106. As shown in FIG. 3C, five new entries are included in the Table 1″ to enable the storage devices 106′ to support RAID-5 functionality. In particular, SSD-0 is associated with the PV group ID <3,0>, HD-1 is associated with the PV group ID <3,1>, HD-2 is associated with the PV group ID <3,2>, HD-3 is associated with the PV group ID <3,3>, and HD 318 is associated with the PV group ID <3,4>. Notably, the PV group IDs associated with RAID-1 remain intact such that the storage devices 106′ can be logically viewed as a two-lane configuration that includes lanes 0-1 (for supporting RAID-1) or a five-lane configuration that includes lanes 0-4 (for supporting RAID-5). Moreover, the PV group IDs associated with speed remain intact such that the storage devices 106′ enable the speed functionality described above in conjunction with FIG. 3A. Thus, embodiments of the invention provide a robust technique that enables the storage space within various storage devices to be directed to different functionalities.

In one embodiment, a persistent group tree is used to maintain the information stored in Table 1. In such a configuration, the persistent group tree is updated each time a storage device is added to or removed from the storage devices 106. The persistent group tree can also be updated in response to the addition of new categories and subcategories that are directed to providing enhanced functionality and control over how data is stored within the storage devices 106. For example, each of the storage devices 106 can be associated with a particular subcategory of a category directed to a write-latency performance of the storage devices, where, for example, the subcategories include “0” for low-latency storage devices, “1” for mid-latency storage devices and “2” for high-latency storage devices.

The aforementioned techniques are utilized by the file system 206, the storage manager 208 and the space allocator 210 when processing write requests generated by applications. The storage manager 208 may determine that some write requests received from the file system 206 should be backed by RAID-1, and, in response, associates those write requests with a PV group ID directed to RAID-1 functionality. For example, if the storage manager 208 receives a write request from the file system to write a file sized at a number N blocks, then the storage manager 208 identifies the two PV group IDs <2,0> and <2,1> and transmits those PV group IDs, as well as the number N blocks, to the space allocator 210. In turn, the space allocator 210 identifies storage devices associated with each of the PV group IDs (e.g., disks 0, 2 and 4 for PV group ID <2,0>, and disks 1 and 3 for PV group ID <2,1>) and proceeds to allocate an amount of space equal to the number N blocks. Finally, the space allocator 210 generates tuples that each includes 1) a physical memory address pointer that points to a memory address within one of the storage devices, and 2) a corresponding length of free blocks that follow the memory address. In turn, the storage manager 208 generates one or more I/O operations based on the tuples to collectively carry out the write request. In this manner, RAID-1 functionality is established using free space within the identified storage devices 106 without requiring that those storage devices 106 are reserved entirely for RAID-1 functionality, as with conventional techniques.

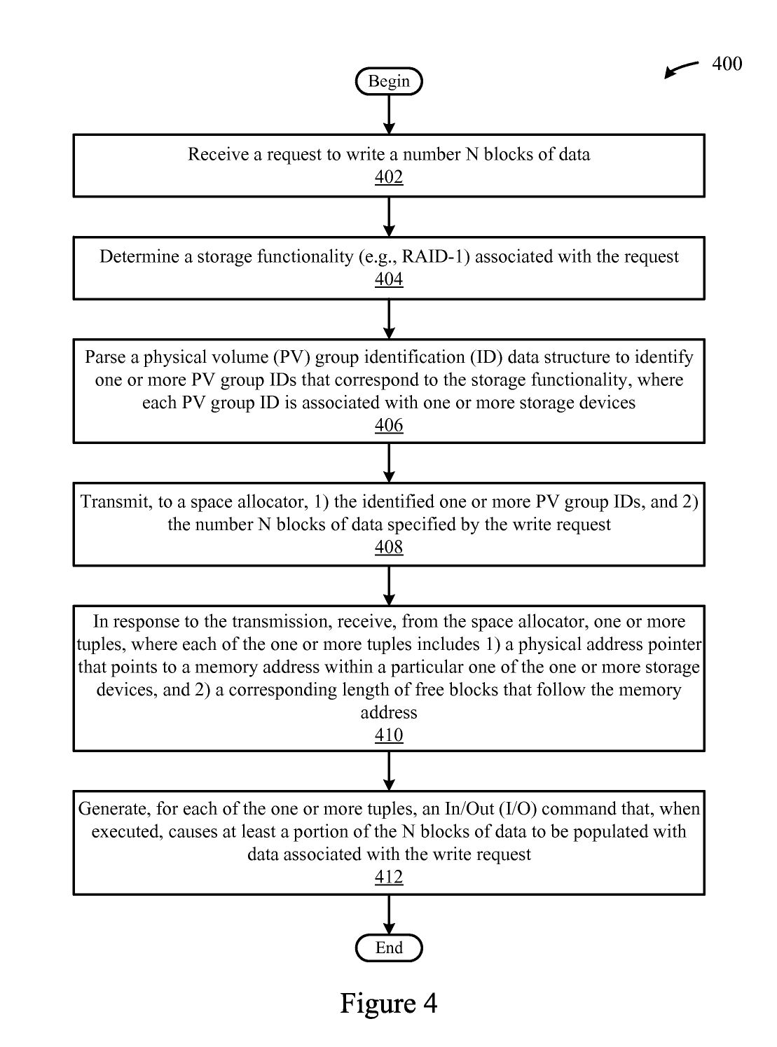

FIG. 4 illustrates a method 400 for receiving and handling a write request generated by a user application, according to one embodiment of the invention. As shown, the method 400 begins at step 402, where the storage manager 208 receives a request to write a number N blocks of data. In one example, a user application, e.g., a photo editing application, generates a request to save a digital photo that requires one-hundred blocks of data to be stored.

At step 404, the storage manager 208 determines a storage functionality (e.g., RAID-1) associated with the request. In one embodiment, the storage manager 208 maintains information about how In/Out (I/O) operations are carried out within the computer system 101 on which the user application is executing. For example, the storage manager 208 can track the rate at which the user application issues I/O operations within the computer system 101. This information can be useful, for example, to determine if the data accessed by the user application should be stored on a storage device 106 that provides the fastest read/write speeds relative to other storage devices 106 included in the computer system 101. The storage manager 208 can also maintain information about the importance of the data that is accessed by the user application. This information can be useful, for example, to determine when one or more redundant copies of data should be stored in different storage devices 106 to protect against data loss in the event of a failure of a storage device on which the data is stored. Additional information can be maintained by the storage manager 208 for each application in order to determine the storage functionality to apply to a request, including the rate at which the application is accessed by a user, the nature of the I/O operations issued by the application (e.g., high ratio of read requests to write requests), a priority of the application relative to other applications (e.g., a database application whose I/O operations must be satisfied as quickly as possible), and the like.

At step 406, the storage manager 208 parses a physical volume (PV) group identification (ID) data structure (e.g., the Table 1 of FIGS. 3A-3B) to identify one or more PV group IDs that correspond to the storage functionality, where each PV group ID is associated with one or more storage devices 106. For example, if, at step 404, the storage manager 208 determines that the storage functionality for the write request is RAID-1, then the storage manager 208, when parsing Table 1, identifies the PV group IDs (<2,0>, <2,1>), where the PV group ID <2,0> is associated with the SSD 310 and the HD 314, and where the PV group ID <2,1> is associated with the HD 312 and the HD 316. In an alternative example, if the storage manager 208 determines that the storage functionality is directed to a fastest-available speed, then the storage manager 208 identifies the PV group ID <1,1>, which is associated only with the SSD 310.

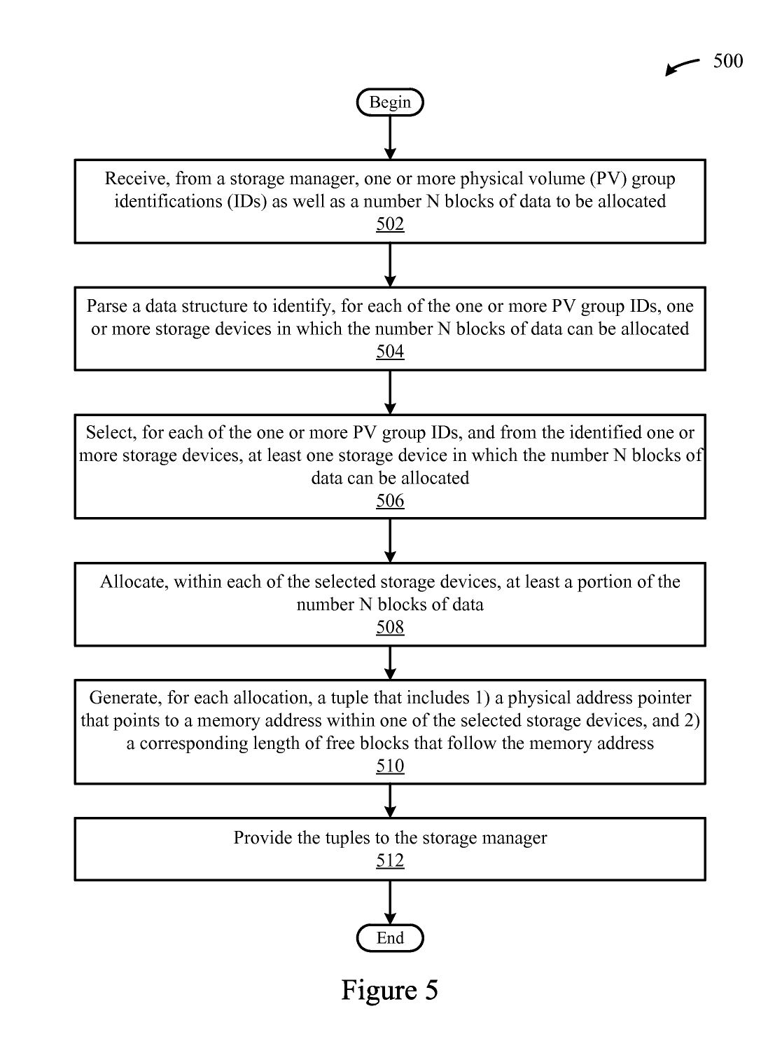

At step 408, the storage manager 208 transmits, to the space allocator 210, 1) the identified one or more PV group IDs, and 2) the number N blocks of data specified by the write request received at step 402. Continuing with the RAID-1 storage functionality example set forth above, the storage manager 208, at step 408, transmits the PV group IDs (<2,0>, <2,1>) and a value of one-hundred that represents the N blocks of data specified by the write request. As described in greater detail below in conjunction with FIG. 5, the space allocator 210 receives the transmitted PV group IDs as well as the required number of data blocks, and then analyzes the storage devices 106 associated with the PV group IDs in view of the required number of data blocks to identify one or more appropriate storage devices 106 against which the write request can be properly executed. In particular, through the analysis, the storage manager 208 generates one or more tuples that include physical address pointers and corresponding lengths of free blocks such that the tuples can be used by the storage manager 208 to collectively carry out the write request.

At step 410, the storage manager 208, in response to the transmission at step 408, receives, from the space allocator 210, one or more tuples, where each of the one or more tuples includes 1) a physical address pointer that points to a memory address within a particular one of the storage devices 106, and 2) a corresponding length of free blocks that follow the memory address. Continuing with the RAID-1 storage functionality example set forth above, a first of the one or more received tuples includes a physical address pointer that points to a memory address within the HD 314—which, again, is associated with the PV group ID <2,0>—and the corresponding length of free blocks that follows the memory address is one-hundred. Continuing with this example, a second of the one or more received tuples can include a physical address pointer that points to a location within the HD 312—which, again, is associated with the PV group ID <2,1>—and the corresponding length of free blocks that follows the memory address is one-hundred.

Notably, although the foregoing examples set forth a scenario where each tuple defines a single physical address pointer and a corresponding length of free blocks, more complex tuples/data structures are within the scope of the invention. For example, embodiments of the invention can utilize tuples that each defines multiple physical address pointers (e.g., an array of physical address pointers) and multiple corresponding lengths of free blocks (e.g., an array of corresponding lengths of free blocks). In this manner, the space allocator 210 can more flexibly allocate free space within the storage devices 106. Consider, for example, an example scenario where a maximum of only eighty contiguous blocks is available within the HD 314. In this scenario, the space allocator 210, to satisfy the write request for one-hundred blocks, could first allocate the eighty aforementioned available blocks, and subsequently allocate twenty blocks from a next-available area of free blocks. In doing so, the space allocator 210 can return a tuple that includes 1) a first physical address pointer that corresponds to a first length of eighty free blocks, and 2) a second physical address pointer that corresponds to a second length of twenty free blocks. Alternatively, the space allocator 210 can return tuples that include only a single physical address pointer and a single corresponding length of free blocks, but are tied together (e.g., using a linked list) to form a sequence of physical address pointers and corresponding lengths of free blocks that can be used to satisfy the write request.

At step 412, the storage manager 208 generates, for each of the one or more tuples, an I/O command that, when executed, causes at least a portion of the N blocks of data specified by the write request to be populated with data associated with the write request. Continuing with the example described above in conjunction with step 410, the storage manager 208 first generates an I/O command that, when executed, causes all one-hundred blocks of the data associated with the write request to be written starting at the memory address within the HD 314 (specified by the first tuple described above at step 410), and, further, generates an I/O command that, when executed, causes all one-hundred blocks of the data associated with the request to be written starting at the memory address within the HD 312 (specified by the first tuple described above at step 410). In this manner, a copy of the data associated with the write request, upon completion of the method 400, remains stored in both the HD 314 and the HD 312, thereby effecting a RAID-1 configuration. For example, if first hardware controller for the lane 302—which includes the SSD 310 and the HD 314—were to fail, a complete copy the data would remain accessible via the HD 312. Similarly, if a second hardware controller for the lane 303—which manages the HD 312 and the HD 316—were to fail, a complete copy of the data would remain accessible via the HD 312.

FIG. 5 illustrates a method 500 for managing requests to allocate space within one or more storage devices, according to one embodiment of the invention. As shown, the method 500 begins at step 502, where the space allocator 210 receives, from the storage manager 208, one or more PV group IDs as well as a number N blocks of data to be allocated. As previously described herein, the one or more PV group IDs as well as a number N blocks of data to be allocated received at step 502 are generated and transmitted by the storage manager 208 at steps 406 and 408 in the method 400 of FIG. 4. Continuing with the overarching example described above in conjunction with FIG. 4—that is, where a user application issues a write request to write one-hundred blocks of data, and the storage manager 208 determines that RAID-1 is the storage functionality—the PV group IDs (<2,0>, <2,1>) are received, and a value of one-hundred is received for the number N blocks of data to be allocated.

At step 504, the space allocator 210 parses a PV group ID data structure to identify, for each of the one or more PV group IDs, one or more storage devices in which the number N blocks of data can be allocated. Continuing with the example set forth above, the space allocator first parses the storage devices 106 associated with the PV group ID <2,0>, which, according to the Table 1 of FIGS. 3A-3C, are SSD 310 and HD 314.

At step 506, the space allocator 210 selects for each of the one or more PV group IDs, and from the identified one or more storage devices, at least one storage device in which the number N blocks of data can be allocated. In one embodiment, the space allocator 210 is configured to select a storage device that is most appropriate with respect to the storage functionality associated with the PV group ID <2,0>. Consider, for example, a scenario where both the SSD 310 and the HD 314 can store all one-hundred blocks required by the write request. At first glance, it would seem that selecting the SSD 310—which as superior read/write performance compared to the HD 314—would be the most logical choice for the space allocator 210. However, the storage functionality associated with the PV group ID <2,0> is associated with RAID-1, which suggests that data redundancy takes precedent over read/write speed. Therefore, the space allocator 210 would select the HD 314 as the storage device from which to allocate the one-hundred blocks of data.

The space allocator 210 continues this selection process for each PV group ID that is received at step 502 (e.g., the PV group ID <2,1>). Upon completion, at step 508, the space allocator 210 allocates, within each of the selected storage devices, at least a portion of the number N blocks of data. Continuing with the example described above, the space allocator 210 identifies one or more locations within the HD 314 that can be used to satisfy the one-hundred block write request. In one example, the space allocator 210 identifies a first location where thirty contiguous blocks are available, and subsequently identifies a second location where seventy contiguous blocks are available. The space allocator 210 tracks this information so that one or more tuples can subsequently be generated for these identified locations and corresponding lengths of blocks, as described below at step 510.

At step 510, the space allocator 210 generates, for each allocation, a tuple that includes 1) a physical address pointer that points to a memory address within one of the selected storage devices, and 2) a corresponding length of free blocks that follow the memory address. At step 512, the space allocator 210 provides the tuples to the storage manager 208.

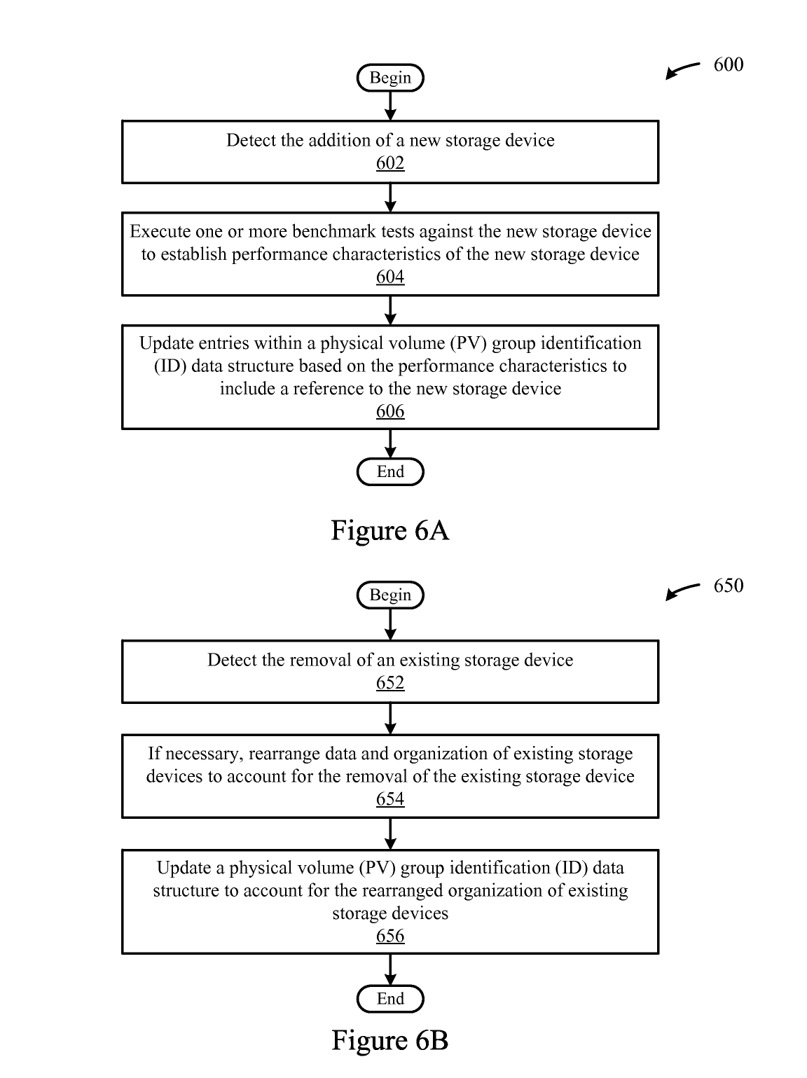

FIG. 6A illustrates a method 600 for adding a new storage device to a collection of storage devices managed using a PV group ID data structure, according to one embodiment of the invention. As shown, the method 600 begins at step 602, where the storage manager 208 detects the addition of a new storage device. Consider, for example, the example shown in FIGS. 3B-3C that involves adding HD 318 to the storage devices 106.

At step 604, the storage manager 208 executes one or more benchmark tests against the new storage device to establish performance characteristics of the new storage device. One benchmark test can include, for example, executing a stream of read/write operations to the new storage device and monitoring the rate at which they are completed, thereby enabling an average read/write speed for the new storage device to be determined Other benchmark tests can include detecting an overall capacity of the storage device, detecting a type of the storage device (e.g., solid state, mechanical, tape, etc.), detecting a hardware controller that manages the new storage device, and the like.

At step 606, the storage manager 208 updates entries within a PV group ID data structure (e.g., Table 1 of FIGS. 3A-3C) based on the performance characteristics to include a reference to the new storage device. Consider, for example, the example shown in FIGS. 3B-3C, which involves updating various PV group IDs in response to the addition of the HD 318, e.g., the PV group IDs <0,0>, <1,0> and <2,0>.

FIG. 6B illustrates a method 650 for removing a storage device from a collection of storage devices managed using a PV group ID data structure, according to one embodiment of the invention. As shown, the method 650 begins at step 652, where the storage manager 208 detects the removal of an existing storage device. Consider, for example, if the HD 316 were removed from Table 1″ immediately after the HD 318 is added. In this example, the HD 316 would be removed from the group of storage devices 106 associated with the PV group IDs <0,0>, <1,0>, <2,1>, and, further the entry for the PV group ID <3,3> would be removed from Table 1″ since the HD 316 is the only storage device 106 associated with the PV group ID <3,3>.

At step 654, storage manager 208 if, necessary, rearranges data and organization of existing storage devices to account for the removal of the existing storage device. In particular, in some cases, removal of the storage device may result in the inability to continue offering a particular one of the storage functionalities. Consider, for example, if, in addition to the removal of the HD 316, the HD 312 and the HD 314 are also removed. In this example, RAID-1 storage functionality would no longer be provided since there is no secondary storage device that can be used to mirror the data stored on the SSD 310. Accordingly, in one embodiment, the storage manager 208 can be configured to warn or display to a user the consequences of the removal of the storage device from the computer system 101 such that he or she fully understands how the removal will affect the storage functionalities that are currently able to be provided. Finally, at step 656, the storage manager 208 updates the PV group ID data structure to account for the rearranged organization of existing storage devices.

In sum, embodiments of the invention provide a category-based space allocation technique that mitigates several of the problems associated with conventional storage techniques. One advantage provided by embodiments of the invention includes the ability to allocate space from a storage device to provide a particular storage functionality (e.g., RAID-5) even though the storage device is primarily used to provide a different storage functionality (e.g., RAID-1). Another advantage provided by embodiments of the invention includes the ability to add new, larger-capacity storage devices to support a particular storage functionality (e.g., RAID-1) without needing to logically truncate the usable space within the new storage devices when other storage devices that provide the same storage functionality are smaller-capacity storage devices. Yet another advantage provided by embodiments of the invention includes the ability to mimic virtually any storage functionality technique that involves organizing data in a specific manner across multiple storage devices.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Certain changes and modifications may be practiced, and it is understood that the invention is not to be limited by the foregoing details, but rather is to be defined by the scope of the appended claims.

What is claimed is:

1. A method for carrying out a request to store data generated by an application, comprising:
receiving, from the application, the request to store data;
determining a storage functionality associated with the request, wherein the storage functionality is implementable using one or more storage devices;
transmitting, to a space allocator:
identifications of the one or more storage devices, and
a size of the data;
receiving, from the space allocator, information about space allocated within at least one of the one or more storage devices; and
issuing, based on the information, one or more In/Out (I/O) commands to store the data in a manner that implements the storage functionality.

2. The method of claim 1, wherein the step of determining the storage functionality comprises:
analyzing the application to determine a rate at which requests are generated by the application;
analyzing a rate at which the application is accessed by a user;
analyzing a nature of the request; and
analyzing a priority of the application relative to other applications.

3. The method of claim 1, wherein the step of determining further comprises identifying, within a data structure, a physical volume (PV) group identification (ID) associated with the storage functionality, wherein the PV group ID is associated with the identifications of the one or more storage devices.

4. The method of claim 3, wherein the information includes:
at least one physical address pointer that points to a memory address within one of the one or more storage devices, and
a corresponding length of free blocks that follow the memory address.

5. The method of claim 1, wherein the storage functionality is directed to providing a particular speed or a particular level of redundancy.

6. The method of claim 1, wherein the one or more storage devices can implement at least two storage functionalities that are different from one another.

7. A method for carrying out a request to allocate space within one or more storage devices, comprising:
receiving, from a storage manager, a request that includes:
identifications of the one or more storage devices, and
a size of data to be stored;
selecting, from the one or more storage devices, at least one storage device in which an amount of space equal to the size of data can be allocated;
allocating, within each of the selected storage devices, an amount of space equal to the size of data; and
transmitting, to the storage manager, information about the space allocations.

8. The method of claim 7, wherein the selected storage devices possesses a largest amount of free space available relative to other ones of the one or more storage devices.

9. The method of claim 7, wherein the selected storage devices possesses a fastest read/write speed capability relative to other ones of the one or more storage devices.

10. The method of claim 7, wherein the information includes:
a first physical address pointer that points to a first memory address within a first storage device of the selected storage devices, and
a first corresponding length of free blocks that follow the first memory address.

11. The method of claim 10, wherein the information further includes:
a second physical address pointer that points to a second memory address within a second storage device of the selected storage devices, and
a first corresponding length of free blocks that follow the second memory address.

12. A method for adding a storage device to a collection of storage devices, comprising:
detecting the addition of the storage device;
executing one or more benchmark tests against the storage device to establish characteristics of the storage device;
identifying, based on the established characteristics of the storage device, at least one storage functionality that the storage device is capable of supporting; and
updating a data structure to include at least one reference to the storage device.

13. The method of claim 12, wherein one of the benchmark tests includes executing a stream of read/write operations to the storage device;
monitoring the rate at which the read/write operations are completed; and
based on the monitoring, determining an average read/write speed for the storage device.

14. The method of claim 12, wherein the benchmark tests include detecting an overall capacity of the storage device, detecting a type of the storage device, or detecting a hardware controller that manages the storage device.

15. A system for carrying out a request to store data generated by an application, comprising:
a processor;
a memory storing instructions that, when executed by the processor, cause the processor to:
receive, from the application, the request to store data;
determine a storage functionality associated with the request, wherein the storage functionality is implementable using one or more storage devices;
transmit, to a space allocator:
identifications of the one or more storage devices, and
a size of the data;
receive, from the space allocator, information about space allocated within at least one of the one or more storage devices; and
issue, based on the information, one or more In/Out (I/O) commands to store the data in a manner that implements the storage functionality.

16. The system of claim 15, wherein the storage functionality is directed to providing a particular speed or a particular level of redundancy.

17. The system of claim 15, wherein the one or more storage devices can implement at least two storage functionalities that are different from one another.

18. A system for carrying out a request to allocate space within one or more storage devices, comprising:
a processor;
a memory storing instructions that, when executed by the processor, cause the processor to:
receive, from a storage manager, a request that includes:
identifications of the one or more storage devices, and
a size of data to be stored;
select, from the one or more storage devices, at least one storage device in which an amount of space equal to the size of data can be allocated;
allocate, within each of the selected storage devices, an amount of space equal to the size of data; and
transmit, to the storage manager, information about the space allocations.

19. The system of claim 18, wherein the selected storage devices possesses a largest amount of free space available relative to other ones of the one or more storage devices.

20. The system of claim 18, wherein the selected storage devices possesses a fastest read/write speed capability relative to other ones of the one or more storage devices.
